(19) United States
(12) Patent Application Publication
(10) Pub. No.: US 2006/0248277 A1
(43) Pub. Date: Nov. 2, 2006

(54) System, method, and apparatus for least recently used determination for caches

(76) Inventor: Anand Pande, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/167,722

(22) Filed: Jun. 22, 2005

Related U.S. Application Data
(60) Provisional application No. 60/676,460, filed on Apr. 29, 2005.

(51) Int. Cl. G06F 13/00

(52) U.S. Cl. 711/136

(57) ABSTRACT

Presented herein are system(s), method(s), and apparatus for maintaining a least recently used list for a cache. In one embodiment, there is presented a circuit for storing a list of a plurality of locations for a cache line. The circuit comprises a multiplexer, a plurality of registers, and a plurality of logic circuits. The multiplexer receives an indicator indicating a cache hit or cache miss for the cache line. The multiplexer provides an output identifying the least recently used location if the indicator indicates a cache miss, and an output identifying an accessed location if the indicator indicates a cache hit. The plurality of registers store identifiers identifying particular ones of the plurality of locations. The plurality of registers comprise a most recently used register and a remaining plurality of registers. The plurality of logic circuits correspond respectively to the remaining plurality of registers and respectively control a corresponding plurality of signals. The plurality of signals enable the remaining plurality of registers to shift. The plurality of logic circuits selectively set at least one of the plurality of signals to allow at least one of the remaining plurality of registers to shift, based on comparisons between the output and the identifiers.

### RELATED APPLICATIONS

This application claims priority to Provisional Application for U.S. Patent, Ser. No. 60/676,460, “System, Method, and Apparatus for Least Recently Used Determination for Caches”, by Pande, filed Apr. 29, 2005, and incorporated herein by reference for all purposes.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Memory accesses are a common bottleneck in a processing pipeline. A processing pipeline often includes stages for fetching an instruction, decoding an instruction, executing the instruction, and updating the program counter. It is desirable for each stage to process the respective functions for different consecutive instructions simultaneously. Fetching and executing the instructions can include making memory accesses. However, memory accesses can take a significantly longer time to perform compared to the other functions. The processing pipeline slows down when the foregoing occurs.

Caches are high-speed memory that can at least partially alleviate the processing pipeline slow down. A processor can access memory locations in a cache at higher speeds as compared to other types of memory. The cost of cache memory is also significantly higher than other types of memory. Therefore, pipeline systems usually include a limited amount of cache memory and bulk amounts of less expensive memory, such as SRAM, or DRAM.

With the limited amount of cache memory, it is desirable to store data in the cache that the processing pipeline is most likely to access. Empirical evaluations have shown that memory locations that are most likely to be accessed are proximate to memory locations that were most recently accessed.

A cache typically operates by storing blocks of memory locations that comprise memory locations that were recently used. When a processor accesses a memory location, the cache stores a block of memory locations, including the memory location, that are proximate to the accessed memory location. The processor accesses the cache for future accesses to memory locations in the block.

As noted above, the amount of cache memory is limited. When the cache is filled, and an additional block is to be added, the least recently used block is removed. Accordingly, caches usually include a chronological list indicating the most recently used to least recently used blocks.

The lists can be maintained in a number of ways, involving combinations of firmware and hardware. Generally, firmware maintained lists are simpler from a design point of view, but slower. Hardware maintained lists are faster, but more complex from a design point of view.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Presented herein are system(s), method, and apparatus for maintaining a least recently used list for a cache.

In one embodiment, there is presented a circuit for storing a list of a plurality of locations for a cache line. The circuit comprises a multiplexer, a plurality of registers, and a plurality of logic circuits. The multiplexer receives an indicator indicating a cache hit or cache miss for the cache line. The multiplexer provides an output identifying the least recently used location if the indicator indicates a cache miss, and an output identifying an accessed location if the indicator indicates a cache hit. The plurality of registers store identifiers identifying particular ones of the plurality of locations. The plurality of registers comprises a most recently used register and a remaining plurality of registers. The plurality of logic circuits correspond to the remaining plurality of registers and control a corresponding plurality of signals. The plurality of signals enable the remaining plurality of registers to shift. The plurality of logic circuits selectively sets at least one of the plurality of signals to allow at least one of the remaining plurality of registers to shift, based on comparisons between the output and the identifiers.

In another embodiment, there is presented a circuit for storing a list of a plurality of locations for a cache line. The multiplexer is operable to receive an indicator indicating a cache hit or cache miss for the cache line, and operable to provide an output identifying a least recently used location if the indicator indicates a cache miss, and an output identifying an accessed location if the indicator indicates a cache hit. The first register is connected to the multiplexer. The second register is connected to the first register. The first logic circuit is connected to the second register, and operable to selectively control a signal causing the second register to shift based on whether an identifier stored in the first register is equal to the output. The third register is connected to the second register. The second logic circuit is connected to the third register, and operable to selectively control a signal causing the third register to shift based on whether the identifier stored in the first register is equal to the output or an identifier stored in the second register is equal to the output.

In another embodiment, there is presented a method for storing a list of a plurality of locations for a cache line. The method comprises receiving a first indicator, said indicator indicating a least recently used location or an accessed location; overwriting an indicator indicating the most recently used location with the first indicator; comparing the indicator indicating a most recently used location with the first indicator; selecting an indicator indicating a next most recently location; and overwriting the selected indicator with the most recently used location if the most recently used location is not equal to the first indicator.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a block diagram of an exemplary processor pipeline system in accordance with an embodiment of the present invention;

FIG. 2 is a block diagram describing an exemplary cache in accordance with an embodiment of the present invention;

FIG. 3 is a block diagram describing an exemplary circuit for maintaining the most recently used blocks in accordance with an embodiment of the present invention;

FIG. 4 is a flow diagram describing maintaining a list of most recently used block in accordance with an embodiment of the present invention.

### DETAILED DESCRIPTION OF THE INVENTION

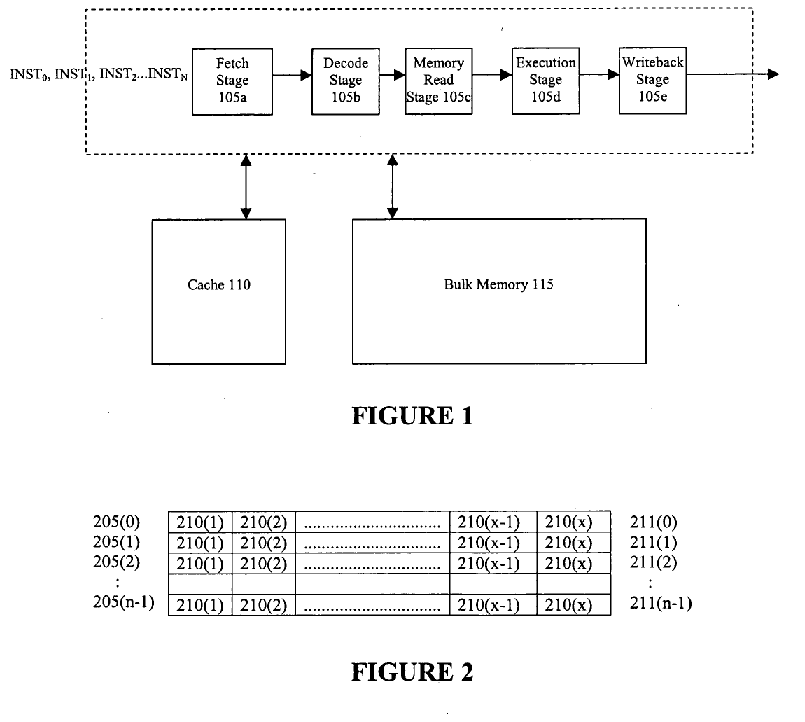

Referring now to FIG. 1, there is illustrated a block diagram describing an exemplary processing pipeline in accordance with an embodiment of the present invention. The processing pipeline 105 includes a fetch stage 105a, a decode stage 105b, a memory read stage 105c, an execution stage 105d, and write-back stage 105d.

The processing pipeline 105 executes instructions, INST₀, INST₁, INST₂, INST₃, . . . INST_{N}. The fetch stage 105a reads the instruction from a memory. The decode stage 105b decodes the instruction. Once the decode stage 105b decodes the instruction, if the instruction is a memory read instruction, the memory read stage 105c reads the indicated memory location in the instruction. The execution stage 105d executes the instruction. Where the instruction is a memory write instruction, the memory writeback stage 105e writes the data to the indicated memory address.

One advantage of a pipeline is that each stage 105 can simultaneously perform its associated function on different instructions. For example, the fetch stage 105a can fetch instruction INST₄, while decode stage 105b decodes instruction INST₃, while memory read stage 105c performs a memory read for instruction INST₂, while execution stage 105b execute an instruction INST₁, while memory write back stage 105e performs a memory write back for instruction INST₀. If each stage performs its respective function in one clock cycle, the processing pipeline 105 completes execution of an instruction every clock cycle. This is the case, even though each instruction would take five clock cycles to execute.

Memory accesses, however, can be one of the biggest bottlenecks in a processing pipeline. and can take a significantly longer time to perform compared to the other functions. The processing pipeline slows down when the foregoing occurs.

The instructions, INST, and data accessed by the instructions are stored in a memory hierarchy. The memory hierarchy comprises a cache 110, and bulk memory 115. The bulk memory 115 usually comprises SDRAM, DRAM, RAM, hard discs, floppy discs, or the like. The bulk memory 115 can also include multiple memories. While the bulk memory 115 is generally inexpensive compared to the cache 110, memory accesses to the bulk memory 115 tend to be significantly slower. The cache 110 is more expensive than the bulk memory 115, but significantly faster.

Generally, the cache 110 stores data and instructions from the bulk memory 115 that are most likely to be accessed by the processing pipeline 105. Empirical evaluations have shown that memory locations that are most likely to be accessed are proximate to memory locations that were most recently accessed. For example, consecutively executed instructions are usually stored in consecutive memory locations, except in cases such as branches, jump to subroutines, and conditional statements.

A cache 110 can either be set associative, or direct mapped. In a fully associative cache, data from any given address location in the bulk memory 115 can be stored at any location in the cache 110. In a set associative cache, data from a given address location in the bulk memory 115 is stored in a particular locations of the cache 110. Each location in the cache 110 is associated with a tag that indicates the bulk memory 115 address and the data stored thereat.

When the processing pipeline 105 accesses a memory location in the bulk memory 115, the cache 110 stores the data from the memory location. When the processing pipeline 105 is to access a memory location, the processing pipeline 105 examines the cache 110 to determine if the cache 110 stores the data from the memory location. A cache hit refers to when the cache 110 stores data from the memory location. A cache miss refers to when the cache 110 does not.

When a cache miss occurs, the cache 110 writes in the accessed data. If the cache 110 is filled to capacity, the cache 110 discards the least recently used data. The cache 110 discards the least recently used data by overwriting the least recently used data with the accessed data.

Referring now to FIG. 2, there is illustrated a block diagram describing an exemplary cache 110 in accordance with an embodiment of the present invention. The cache 110 comprises a plurality of lines 205(0) . . . 205(n−1). Each line 205 can store x data words 120 from the bulk memory 115 in locations 210(1) . . . 210(x).

During a cache miss, the cache 110 writes the accessed data word 115( ) from the bulk memory 115 to a location 210 in one of the lines 205. The particular line 205 written to is a function of the address of the data word in the bulk memory 115. For example the particular line can be line 205(i), where i equals the address of the data word 115 mod n. The value n is usually an integer power of two. Therefore, the value i can be determined by examining certain significant bits of the data word 115 address.

Each line 205 is also associated with a least recently used (LRU) circuit 211. The LRU Circuit 211 identifies and lists the x locations from the line 205 associated therewith. The LRU Circuit 211 lists the x locations from the line 205 in an order indicating the particular one of the x locations that was most recently used by the processing pipeline 205 through the particular one of the x locations that was least recently used by the processing pipeline 105.

The LRU Circuit 211 indicates the particular location 210(1) . . . 210(x) that stores an accessed data word 115 during a cache miss. During a cache hit, the LRU Circuit 211 associated with the line 210 that was accessed, updates. The LRU Circuit 211 updates to indicate that the particular location 210(1) . . . 210(x) was most recently used.

During a cache miss, if the line 205 associated with the address of the accessed data word 115 is full, the cache 110 writes the data word 115 to the particular location 210(1) . . . 210(x) storing the data word that was least recently used. The LRU Circuit 211 updates to indicate that the location 210 (1) . . . 210(x) that was least recently is now most recently used.

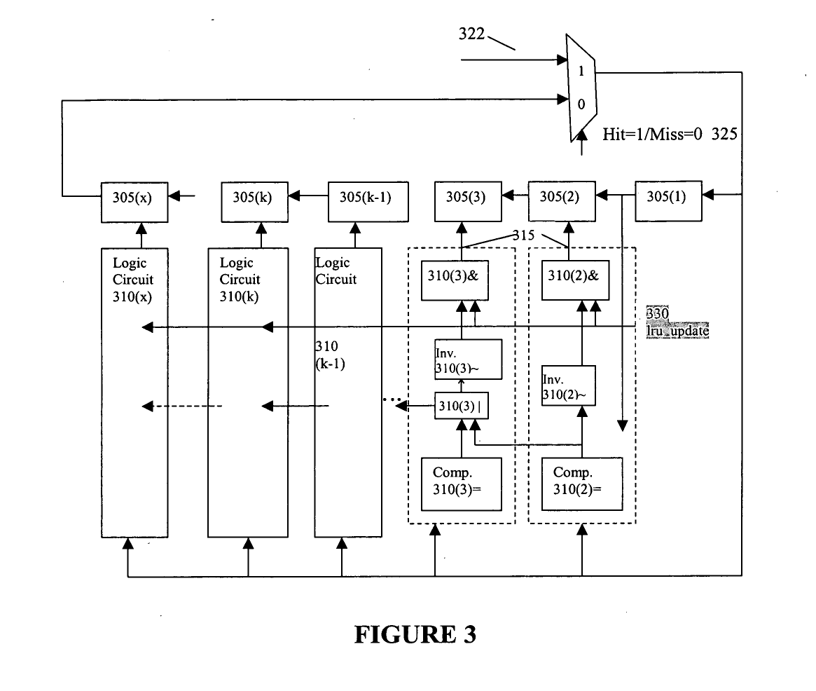

Referring now to FIG. 3, there is illustrated a block diagram describing an exemplary LRU Circuit 211 in accordance with an embodiment of the present invention. For a cache 110 comprising x words 210 per line (x-way associative), the LRU Circuit 211 comprises x registers 305(1) . . . 305(x). The registers 305(1) . . . 305(x) store identifiers identifying a particular location 210(1) . . . 210(x).

The registers 305(1) . . . 305(x) form a list of identifiers identifying each of the particular locations 210(1) . . . 210(x) in reverse chronological access order. Register 305(1) stores an identifier identifying the location 210 that was most recently accessed. Register 305(x) stores an identifier identifying the location 210 that was least recently used.

The registers 305(1) . . . 305(x) are connected such that after a shift in, a given register 305(k) stores the contents of register 305(k−1) prior to the shift in. Logic circuits 310(2) . . . 310(x) provide shift enable signals 315(2) . . . 315(x) to registers 305(2) . . . 305(x), respectively. When a shift enable signal, e.g., shift enable signal 315(k), indicates a shift, the register 305 receiving the shift enable signal, e.g., register 305(k) shifts in the contents from register 305(k−1).

The register 305(1) receives the output of a multiplexer 320. The multiplexer 320 receives the contents of the register 305(x), the register storing an identifier identifying the location 210 that was least recently used, and a cache hit identifier, and another identifier 322. During a cache hit, the identifier 322 indicates the location 210 that was accessed.

A hit/miss signal 325 controls the multiplexer 320. When a cache hit occurs with respect to a line 205 associated with the LRU circuit 211, the location 210 that was accessed becomes the most recently used location 210. When a cache miss occurs with respect to the cache line 205 associated with the LRU Circuit 211, the data word accessed from the bulk memory is written to the least recently used location 210, the location 210 identified by the identifier stored in register 305(x). The least recently used location 210 now becomes the most recently used location.

During a cache miss with respect to the cache line 205 associated with the LRU circuit 211, the multiplexer 320 provides the contents of register 305(x), an identifier identifying the least recently used location 210, to register 305(1). The LRU update signal 330 is asserted causing register 305(1) to shift in the contents of register 305(x).

Comparators 310(2)= . . . 310(x)= compare the contents of registers 305(1) . . . 305(x−1) (before the update). In the case of a cache miss, each comparator 310(2)= . . . 310(x)= will output a logical “0”, indicating that the contents of registers 305(1) . . . 305(x−1) do not match the output of the multiplexer 320. The outputs of each of the OR gates 310(3)| . . . 310(x)| will be a logical “0”, causing the invertors 310(2)˜ . . . 310(x)˜ to be a logical “1”.

AND gates 310(2)& . . . 310(x)& receive the LRU update signal 330. Where the LRU update signal 330 is asserted and the outputs of the inverters 310(2)˜ . . . 310(x)˜ are “1”, the AND gates 310(2)& . . . 310(x)& output logical “1's”. The output of the AND gates 310(2)& . . . 310(x)& are the shift enable signals 315(2) . . . 315(x). This causes each of the registers 305(2) . . . 305(x) to shift in the contents of registers 305(1) . . . 305(x−1).

During a cache hit with respect to the cache line 205 associated with the LRU circuit 211, the multiplexer 320 provides the identifier identifying the accessed location 210 to register 305(1). An LRU update signal 330 is asserted. Register 305(1) receives the LRU update signal 330 causing register 305(1) to shift in the output of the multiplexer 320. The register 305(1) also shifts out its output, prior to the shift in. The logic circuits 310 also receive the identifier identifying the accessed location 210 for comparison by a comparator 310( )= to the contents of the register 305 associated therewith.

The comparators 310(2)= provides its output to OR gates 310(3). Comparators 310(3)= . . . 310(x)= provide outputs to OR gates 310(3)| . . . 310(x)|, respectively. Each of the OR gates 310(4)| . . . 310(x)| receives the output of OR gate 310(3)| . . . 310(x−1)|, respectively.

Where a given register, e.g., register 305(k) stores an identifier that identifies the location 210 that was accessed, the register 305(k) provides the identifier to comparator 310(k+1)=. The comparator 310(k+1)=detects that the identifier from register 305(k) and the identifier from the multiplexer 320 are the same. Accordingly, the comparator 310(k+1)=outputs a logical “1”.

The OR gate 310(k+1)| receives the logical “1”, causing OR gates 310(k+1)| . . . 310(x)| to output a logical “1”. Inverters 310(k+1)˜ . . . 310(x)˜ invert the output of the OR gates 310(k+1)| . . . 310(x)|, thereby providing a logical “0” to AND gates 310(k+1)& . . . 310(x)&. Each of the AND gates also receives the LRU update signal 330.

When the inverters 310(k+1)˜ . . . 310(x)˜ provide logical “0's” to AND gates 310(k+1)& . . . 310(x)&, the AND gates 310(k+1)& . . . 310(x)& provide a logical “0” output to the register 305(k+1) . . . 305(x). This prevents registers 305(k+1) . . . 305(x) from shifting.

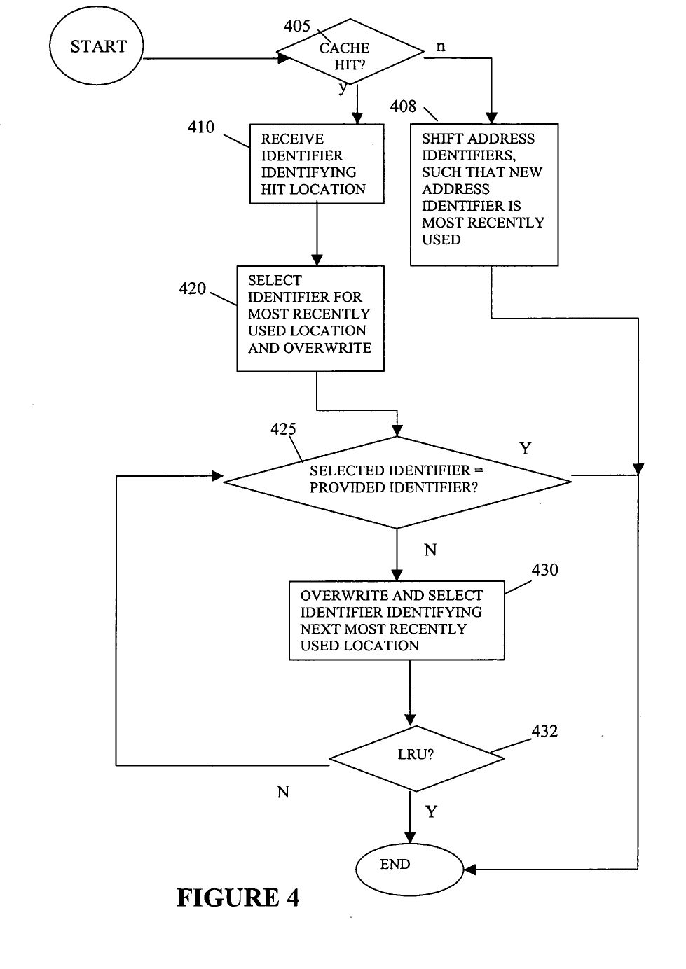

Referring now to FIG. 4, there is illustrated a flow diagram describing updating a least recently used list for a cache line in accordance with an embodiment of the present invention. At 405, a determination is made whether there is a cache hit or miss with respect to the cache line. Where at 410, there is a miss, a list storing the location identifiers is shifted (408), such that a new identifier identifying a new location becomes the most recently used identifier in the list, and the least recently used identifier is discarded. The process is then completed.

Where at 405, there is a hit, an identifier identifying the hit location 210 is received (410). At 420, the identifier identifying the most recently used location is selected and overwritten by the identifier provided during either 410 or 415 (the provided identifier). At 425, the selected identifier is compared to the provided identifier. If there is not a match during 425, at 430, the identifier identifying the next most recently used location is overwritten by the selected identifier and selected. The foregoing continues until a match occurs at 425, or when the selected identifier is the least recently used identifier (432). When a match occurs at 425 or the selected identifier is the least recently used identifier at 432, the update is complete.

The invention will now be described with respect to the following examples. The cache line 205 associated with the LRU includes four locations 210(1) . . . 210(4). Accordingly, the LRU circuit 211 includes four registers 305(1), 305(2), 305(3), 305(4). Lets assume, the LRU circuit 211 is initially as follows:

| Register 305(4) | Register 305(3) | Register 305(2) | Register 305(1) |
|---|---|---|---|
| Location 210(3) | Location 210(4) | Location 210(1) | Location |
| | | | 210(2) |

In one example, a hit to location 210(1) occurs. Thus, only comparator 310(3)= will produce a “1”. This will mask the updates to registers 305(3) and 305(4). Register 305(2) is overwritten with the contents of register 305(1), and register 305(1) is overwritten with an identifier identifying location 210(1). The updated LRU circuit 211 is shown below.

| Register 305(4) | Register 305(3) | Register 305(2) | Register 305(1) |
|---|---|---|---|
| Location 210(3) | Location 210(4) | Location 210(2) | Location |
| | | | 210(1) |

In another example, a hit to location 210(4) occurs. In this case, comparator 310(4)= will produce a “1”. This will mask the update to register 305(4). Register 305(3) is overwritten with the contents of register 305(2), register 305(2) is overwritten with the contents of register 305(1), and register 305(1) is overwritten with the identifier identifying 210(4). The update LRU circuit 211 is shown below:

| Register 305(4) | Register 305(3) | Register 305(2) | Regi ster305(1) |
|---|---|---|---|
| Location 210(3) | Location 210(1) | Location 210(2) | Location |
| | | | 210(4) |

The degree of integration of the system will primarily be determined by speed and cost considerations. Because of the sophisticated nature of modern processor, it is possible to utilize a commercially available processor, which may be implemented external to an ASIC implementation. If the processor is available as an ASIC core or logic block, then the commercially available processor can be implemented as part of an ASIC device wherein certain functions can be implemented in firmware. Alternatively, the functions can be implemented as hardware accelerator units controlled by the processor. In one representative embodiment, the encoder system is implemented as a single integrated circuit (i.e., a single chip design).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope.

Therefore, it is intended that the present invention not be limited to the particular embodiment disclosed, but that the present invention will include all embodiments falling within the scope of the appended claims.

1. A circuit for storing a list of a plurality of locations for a cache line, said circuit comprising:
a multiplexer for receiving an indicator indicating a cache hit or cache miss for the cache line, said multiplexer providing an output identifying an accessed location if the indicator indicates a cache hit;
a plurality of registers for storing identifiers identifying particular ones of the plurality of locations, said plurality of registers comprising a most recently used register and a remaining plurality of registers;
a plurality of logic circuits, said plurality of logic circuits corresponding respectively to the remaining plurality of registers, for controlling a corresponding plurality of signals, said plurality of signals respectively enabling the remaining plurality of registers to shift; and
wherein the plurality of logic circuits selectively sets at least one of the plurality of signals to allow at least one of the remaining plurality of registers to shift, based on comparisons between the output and the identifiers.

2. The circuit of claim 1, wherein each of the plurality of logic circuits comprise:
a comparator for comparing a particular one of the identifiers to the output.

3. The circuit of claim 1, wherein each of the plurality of logic circuits comprise:
an AND gate for selectively masking an update signal from a portion of the plurality of registers.

4. The circuit of claim 3, wherein each of the plurality of logic circuits comprise:
an inverter for providing a masking signal to the AND gate.

5. The circuit of claim 1, wherein the plurality of registers comprise:
a first register for storing an identifier identifying a first location from the cache line;
a second register for storing an identifier identifying a second location from the cache line, said second register connected to the first register; and
a third register for storing an identifier identifying a third location from the cache line, said third register connected to the second register.

6. The circuit of claim 5, wherein the plurality of logic circuits comprise:
a first logic circuit for selectively providing a shift signal to the second register;
a second logic circuit for selectively providing a shift signal to the third register.

7. The circuit of claim 6, wherein the first logic circuit comprises a first comparator for indicating whether the first identifier and the output are equal.

8. The circuit of claim 7, wherein the second logic circuit comprises:
a second comparator for indicating whether the second identifier and the output are equal; and
an OR-gate for indicating whether any one of the first comparator or second comparator indicate that any one of the first identifier and the second identifier are equal to the output.

9. The circuit of claim 8, comprising:
a fourth register for storing an identifier identifying a fourth location from the cache line, said fourth register connected to the third register;
a third logic circuit for selectively providing a shift signal to the fourth register, said third logic circuit comprising:
a third comparator for indicating whether the second identifier and the output are equal; and
an OR-gate for indicating whether any one of the first comparator, second comparator, or third comparator indicate that any one of the first identifier, second identifier, and third identifier are equal to the output.

10. A circuit for storing a list of a plurality of locations for a cache line, said circuit comprising:
a multiplexer operable to receive an indicator indicating a cache hit or cache miss for the cache line, and operable to provide an output identifying a least recently used location if the indicator indicates a cache miss, and an output identifying an accessed location if the indicator indicates a cache hit;
a first register connected to the multiplexer;
a second register connected to the first register;
a first logic circuit connected to the second register, said first logic circuit operable to selectively control a signal causing the second register to shift based on whether an identifier stored in the first register is equal to the output;
a third register connected to the second register; and
a second logic circuit connected to the third register, said second logic circuit operable to selectively control a signal causing the third register to shift based on whether the identifier stored in the first register is equal to the output or an identifier stored in the second register is equal to the output.

11. The circuit of claim 10, further comprising:
a fourth register connected to the third register.

12. The circuit of claim 11, further comprising:
a third logic circuit connected to the fourth register, said second logic circuit operable to selectively control a signal causing the fourth register to shift based on whether any one of the identifiers stored in the first register, the identifier stored in the second register, or an identifier stored in the third register, is equal to the output.

13. A method for storing a list of a plurality of locations for a line, said method comprising:
receiving a first indicator, said indicator indicating a newly accessed location or an accessed location;
overwriting an indicator indicating the most recently used location with the first indicator;
comparing the indicator indicating a most recently used location with the first indicator;
selecting an indicator indicating a next most recently location; and
overwriting the selected indicator with the most recently used location if the most recently used location is not equal to the first indicator.

14. The method of claim 13, comprising:
a) comparing the selected indicator to the first indicator;
b) selecting another indicator indicating the next most recently used location;
c) overwriting the selected indicator with the previously selected indicator if the previously selected indicator is not equal to the first indicator; and
repeating a)-c) until the selected indicator and the first indicator are equal or until the selected indicator is an indicator indicating a least recently used location.
